(19) United States
(12) Patent Application Publication
(10) Pub. No.: US 2020/0189808 A1
(43) Pub. Date: Jun. 18, 2020

(54) CASE FOR SECURELY TRANSPORTING HIGH-VALUE GOODS

(71) Applicant: NOTTINGHAM SPIRK DESIGN ASSOCIATES, Cleveland, OH (US)

(72) Inventors: Mike Bilinski, Cleveland, OH (US); Maynard Payumo, Parma, OH (US); Jim Szpak, Cleveland Heights, OH (US); Bill Rabbitt, Cleveland, OH (US); Jason Tilk, Cleveland Heights, OH (US)

(21) Appl. No.: 16/713,511

(22) Filed: Dec. 13, 2019

Related U.S. Application Data
(60) Provisional application No. 62/779,103, filed on Dec. 13, 2018.

(51) Int. Cl. B65D 43/16; B65D 43/02; G07C 9/00; G07C 9/33

(52) U.S. Cl. CPC B65D 43/164; B65D 43/0202; G07C 9/00571; G07C 9/00896; G07C 2009/0092; B65D 2203/10; B65D 2203/12; B65D 2211/00; G07C 9/33

(57) ABSTRACT

A case for securely transporting high-value consumer goods includes a case body having a main cavity within which the high-value consumer goods may be stored for transporting and a lid including a door. The case body has installed or formed thereon a first linking mechanism portion and the lid has installed or formed thereon a second linking mechanism portion that interacts with the first linking mechanism portion to link and unlink the lid to the case body. The door, when closed, covers the first linking mechanism portion and the second linking mechanism portion and, when open, exposes at least one of the first linking mechanism portion and the second linking mechanism portion such that linking and unlinking of the lid to the case body is possible only when the door is open.

### BACKGROUND

Currently, in the United States, many states have made legal the growth, harvest, sale, and distribution of cannabis (aka marijuana) and its derivate products. As a result, more people are taking advantage of the plant's benefits. Although generally legal and available, these goods are highly regulated and their value is also relatively high. Safety and security in the distribution of these high-value goods are paramount but pose unique challenges. For example, some states require very close understanding and documenting of the products, from specifics of the plant's origins to the chain of custody of products in distribution.

With the rapid increase in the consumption of these high-value goods, such challenges are becoming ever more prevalent. Growers, producers, and distributors of these and other high-value goods have a need for secure and generally affordable storage and transport devices.

### BRIEF SUMMARY OF THE INVENTION

In accordance with one aspect of the invention, a case for securely transporting high-value goods is provided. Designed to provide secure transport of high-value consumer goods such as, for example, cannabis-based products, this case has features to safeguard against theft, tampering, or damage while products are moved through the supply chain. The case may be made of impact resistant materials (e.g., high-density polyethylene, high-impact polystyrene, polypropylene, polychlorotrifluoroethylene, etc.) and may have an electromechanical locking door that opens only at designated locations as determined by GPS tracking (i.e., geo-fencing). The case may also be thermally insulated.

During transport, various cases may be secured to each other and/or affixed to the vehicles they are packed in using a security harness connected to a security port or bracket in the case. An indicator light on the lid may also be activated upon arrival to a case's final destination making it easy for a person to locate the corresponding case in the vehicle.

When at a selected location (i.e., within the geo-fence), the case may be opened by entering a code using a digital keypad. The code may be a rolling passcode given to authorized users. In one embodiment, the case may also be opened by a remote signal. Within the case may be temperature and humidity sensors that measure whether the product has been kept in optimal conditions during transport. All these measurements (e.g., location, temperature, humidity, etc.) may be tracked in real-time (or near real-time) and transmitted to cloud-based storage that can be accessed by shippers and receivers at any time.

In the event an unauthorized user opens the case (e.g., by force), the tampering may be detected and an alarm (local and/or remote) may be triggered. In one embodiment, an embedded camera may be activated to capture photos or footage of the perpetrator. Any captured information may be sent to the cloud-based storage for later analysis and availability to the pertinent authorities.

The case may also accommodate removable liners with handles. The goods may be stored in the liners which may be easily removed and delivered to the ultimate recipient for a more seamless delivery process. The liners may also include RFID tags readable by the case's controller to identify specific liners and removal or insertion of the specific liners into the case.

The case may be stackable. The case body may also come in a variety of volumes that share the same rim size. This way the same lid may fit case bodies of different volumes. The lid may be internally secured to the case body by a secure linking mechanism that is accessible only to authorized users having the appropriate credentials to open the door.

These and other advantages of the invention will become apparent when viewed in light of the accompanying drawings, examples, and detailed description.

### BRIEF DESCRIPTION OF THE DRAWINGS

The accompanying drawings, which are incorporated in and constitute a part of the specification, illustrate various example systems, methods, and so on, that illustrate various example embodiments of aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

FIG. 1 illustrates a perspective view of an exemplary case for securely transporting high-value consumer goods.

FIG. 2 illustrates a front view of the exemplary case for securely transporting high-value consumer goods of FIG. 1.

FIG. 3 illustrates a top view of the exemplary case for securely transporting high-value consumer goods of FIG. 1.

FIG. 4 illustrates a perspective view of the exemplary case for securely transporting high-value consumer goods of FIG. 1 with its door open.

FIG. 5 illustrates a rear view of the exemplary case for securely transporting high-value consumer goods of FIG. 1 with its door open.

FIG. 6 illustrates a top-front view of the exemplary case for securely transporting high-value consumer goods of FIG. 1 with its door made transparent.

FIG. 7 illustrates a cross-sectional view of the exemplary case for securely transporting high-value consumer goods of FIG. 1.

FIG. 8 illustrates a perspective view of a case body of the exemplary case for securely transporting high-value consumer goods of FIG. 1.

FIG. 9 illustrates a top view of the case body of FIG. 8.

FIG. 10 illustrates a bottom view of a smart lid of the exemplary case for securely transporting high-value consumer goods of FIG. 1.

FIG. 11 illustrates a front view of a sliding clasp of the exemplary case for securely transporting high-value consumer goods of FIG. 1.

FIG. 12 illustrates a perspective view of the sliding clasp of FIG. 11.

FIG. 13 illustrates a front view of the exemplary case for securely transporting high-value consumer goods of FIG. 1 with its smart lid separated from its case body.

FIG. 14 illustrates a schematic diagram of circuitry of the exemplary case for securely transporting high-value consumer goods of FIG. 1.

### DETAILED DESCRIPTION

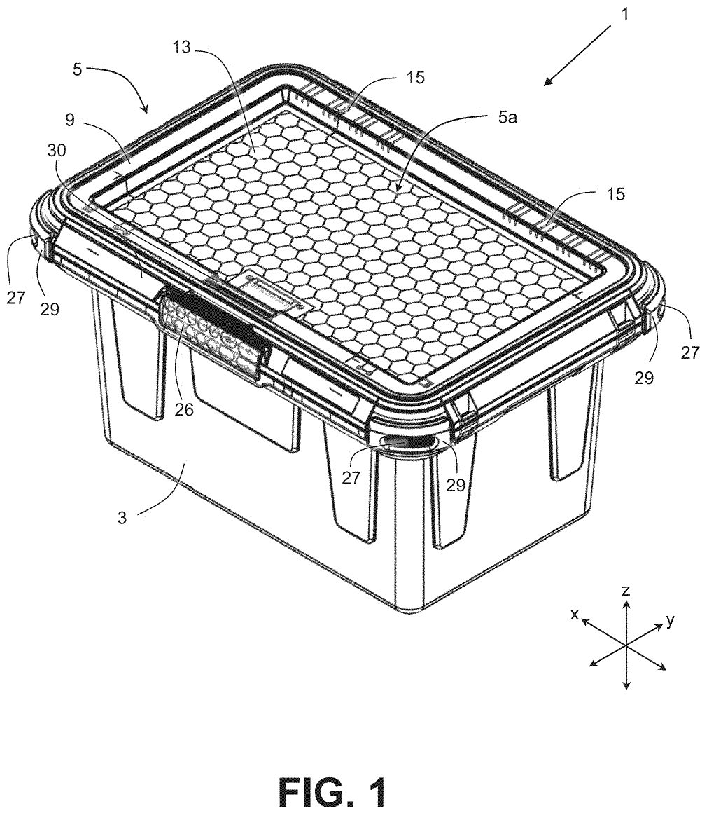

FIGS. 1-10 illustrate various different views of an exemplary case 1. The case 1 is designed to provide secure transport of high-value goods such as, for example, cannabis-based products. As described in detail below, the case 1 has features to safeguard against theft, tampering, or damage while the high-value products are moved through the supply chain. Moreover, the case 1 may be designed to communicate its whereabouts so that location of the high-value goods is well-understood at all times.

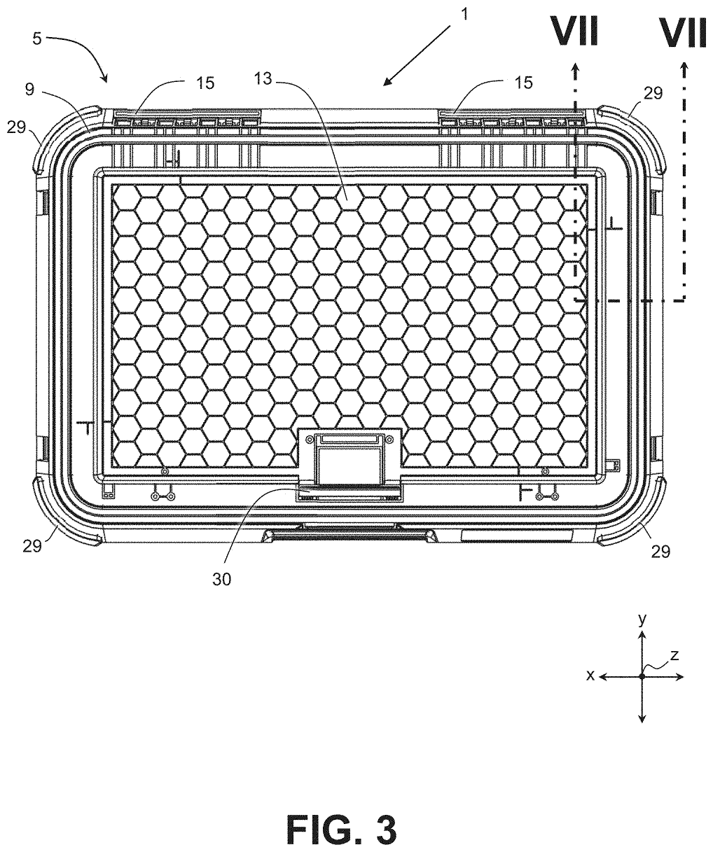

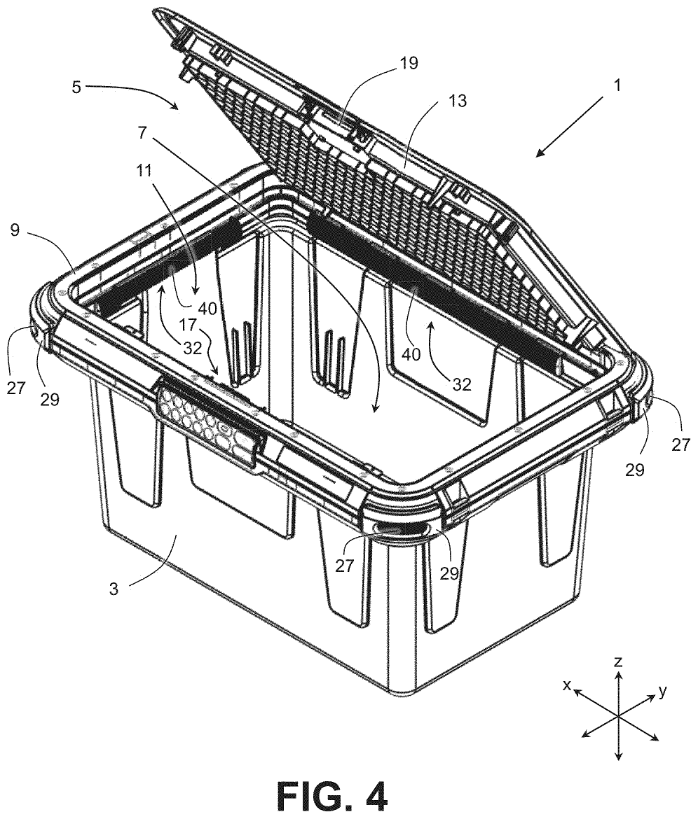

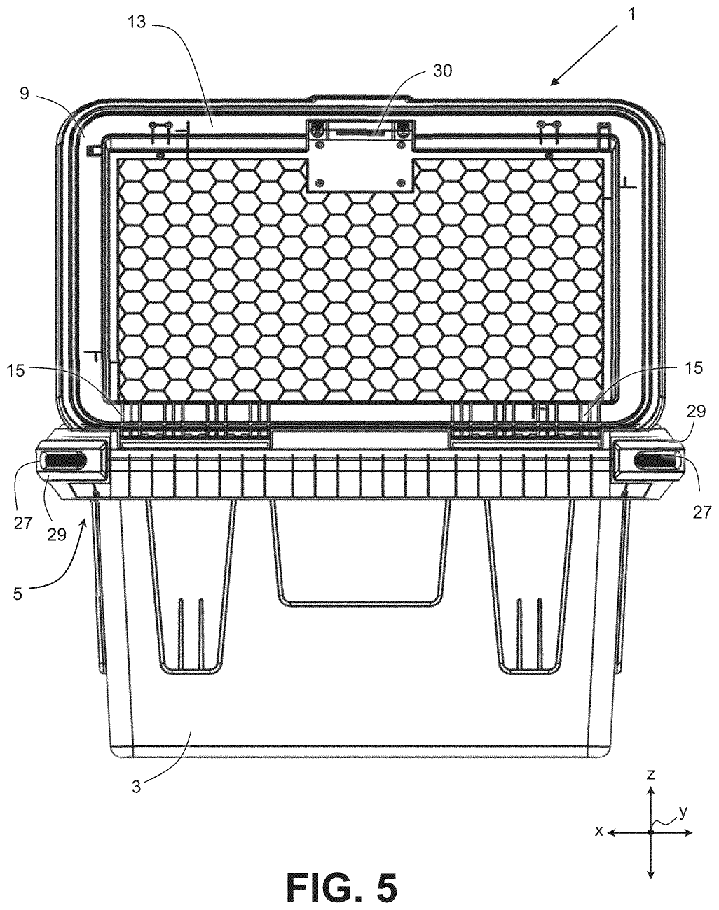

The case 1 is comprised of two main components: a case body 3 and a smart lid 5 that links or mounts to the case body 3. As best shown in FIGS. 4, 6, 8, and 9, the case body 3 has a main cavity 7 within which the high-value consumer goods may be stored for transporting. As best shown in FIG. 4, the smart lid 5 may include a shroud 9 having formed thereon an opening 11. The lid 5 may also include a door 13 that closes to cover the opening 11 (or at least most of the opening 11) and opens to expose the main cavity 7. As best shown in FIGS. 3 and 5, the door 13 may be connected to the shroud 9 (or generally to lid 5) by hinges 15. Thus, the door 13 is operable to open to the position shown in FIGS. 4 and 5 to expose the main cavity 7 and to close to the position shown in FIGS. 1-3 to cover the main cavity 7.

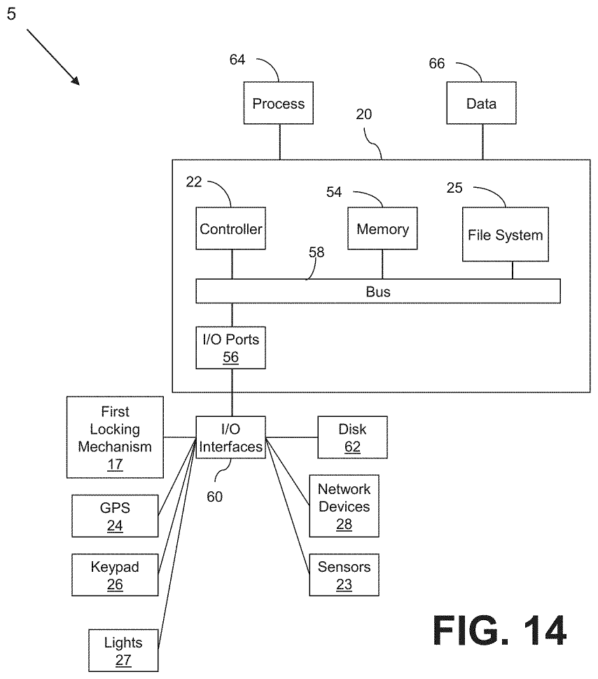

The smart lid 5 may include circuitry 20 to electronically control various functions of the lid 5. As exemplarily shown in FIG. 14, the lid 5 may include a controller 22 operably to connected to a door locking mechanism 17 to unlock the door 13. The lid 5 may also include sensors 23 to sense conditions in the main cavity 7 and communicate those conditions to the controller 22 to report or respond accordingly.

In one embodiment, the lid 5 may include a temperature sensor 23 to measure a temperature inside the case 1 and transmit a temperature signal to the controller 22. In one embodiment, the lid 5 may include a humidity sensor 23 to measure a humidity inside the case 1 and transmit a humidity signal to the controller 22. In one embodiment, the lid 5 may include a light sensor 23 that may operate by detecting light inside the case 1 and transmit a light signal to the controller 22. The controller 22 may be configured to detect opening of the door 13 when receiving the light signal while the door 13 is unlocked. Light inside the case 1 while the door 13 is unlocked likely means that the door 13 has been opened. The controller 22 may also be configured to detect tampering when receiving the light signal while the door 13 is locked. Light inside the case 1 while the door 13 is locked likely means that the case body 3 or the lid 5 have been tampered with.

The controller 22 may then, based on the temperature, humidity, or light signals, store in the file system 25 data regarding conditions inside the case 1. The lid 5 may also include the network devices 28 operably connected to the controller 22 to transmit the data regarding the conditions inside the case 1 to a remote location. In one embodiment, the controller 22 causes the network devices 28 to transmit a remote alarm or the lid 5 may include a local alarming device that the controller 22 may activate to produce a local alarm (e.g., sound, light, etc.) based on the conditions inside the case 1.

The shroud 9 (or generally the lid 5) may include the first door locking mechanism 17 that interacts with a second door locking mechanism 19 included in the door 13. The first and second door locking mechanisms 17, 19 may interact to lock and unlock the door 13 to the shroud 9 (or generally to lid 5). The first door locking mechanism 17 may include one or more latch bolts while the second door locking mechanism 19 may include a strike plate that interacts with the latch bolts.

The smart lid 5 and, specifically the controller 22, may electronically control the first or second door locking mechanism 17, 19. As exemplarily shown in FIG. 14, the controller 22 may be operably connected to the first door locking mechanism 17 to control locking and unlocking of the door 13. The first door locking mechanism 17 may include, for example, servos that, under the control of the controller 22, retract spring-loaded latch bolts from the strike plate in the door 13, to unlock the door 13. Upon release, the spring-loaded latch bolts 17 may return to the locked position by engaging the strike plate 19 when the door 13 is closed. Locking and unlocking of the door 13 may be accomplished in other ways from those described herein and, thus, the first and second door locking mechanisms 17, 19 may be embodied by structures other than the exemplary latch bolts and strike plate described above.

In one embodiment, the lid 5 includes a GPS tracking device 24 configured to transmit a location signal to the controller 22 identifying the geographical location of the case 1. This location signal may be used in geofencing-based unlocking of the door 13 of the case 1. So, for example, the controller 22 may be programmed to, based on the location signal, permit unlocking of the door 13 only within one or more specific geographical areas. Based on a purchase order, for example, the delivery location of the high-value goods may be known. Therefore, the case 1 may be made to unlock the door 13 only at or near the delivery location.

It is likely multiple cases 1 would be transported in the same delivery vehicle (e.g., truck or van). As can be seen from FIG. 1, the smart lid 5 (and/or the door 13) may have formed thereon a top depression 5a that matches or corresponds to the bottom of the case body 3. This way a case 1 may be stacked securely (e.g., no slippage) atop another case 1. In one embodiment, the lid 5 includes lights 27 (e.g., LED lights) operably connected to the controller 22. The controller 22 may be programmed to, based on the location signal, control to turn on or flash the lights 27 at the delivery location to identify a specific case 1 that corresponds to the delivery location. The lights 27 would greatly help a delivery person identify a specific case 1, among potentially multiple cases 1, that is to be removed from the delivery vehicle. The controller 22 may control to turn off the lights 27 when the case 1 is not yet or no longer at the specific geographical area corresponding to the delivery location.

The case 1 (including the case body 3 and the smart lid 5) may be made of impact resistant materials (e.g., high-density polyethylene, high-impact polystyrene, polypropylene, polychlorotrifluoroethylene, etc.). The lid 5 may also include or have formed thereon bumpers 29 disposed at corners or vertices of the lid 5 and configured to absorb impact to protect the integrity of the lid 5 and the case 1. The bumpers 29 may protrude horizontally (i.e., front, back, and sides) further than any other feature of the lid 5 so that the bumpers 29, rather than the other features, may engage adjacent items (e.g., other cases 1, walls, etc.). In the illustrated embodiment, the bumpers 29 each has a recess in which a light 27 resides. The bumper 29, thus, may protect the light 27 from impact during transport.

The lid 5 may further include a keypad 26. When at a selected location (i.e., within the geofence), a user may unlock the door 13 by entering a code using the keypad 26. The code may be a rolling passcode given to authorized users. The keypad 26 may transmit to the controller 22 the entered code. The controller 22 may be configured to, based on the received local code and/or the location signal from the GPS 24, control to actuate the locking mechanism 17 to unlock the door 13.

In one embodiment, the door 13 may instead or in addition be unlocked based on a received remote signal. The circuitry 20 of the lid 5 may include a network device 28 (e.g., a receiver) configured to receive signals including at least a remote unlocking signal and to transmit an equivalent unlocking signal to the controller 22. The controller 22, for its part, may control to actuate the locking mechanism 17 to unlock the door 13 based at least in part on the remote unlocking signal.

It is likely multiple cases 1 would be transported in the same vehicle (e.g., delivery truck or van) to be delivered to the same location. In one embodiment, the controller 22 may be configured to, via the network devices 28, communicate (e.g., wirelessly) with controllers 22 of nearby cases 1. Cases 1 may communicate with each other so that, for example, if multiple cases 1 are at their delivery location and a user enters the correct code in the keypad 26 of one of the cases 1, the controllers 22 of the multiple cases control to unlock their respective doors 13. This would save time.

When the door locking mechanism 17 unlocks it, the door 13 may be opened using the handle 30. The door 13, when unlocked, pivots about the hinges 15 to expose the main cavity 7, as shown in FIGS. 4 and 5.

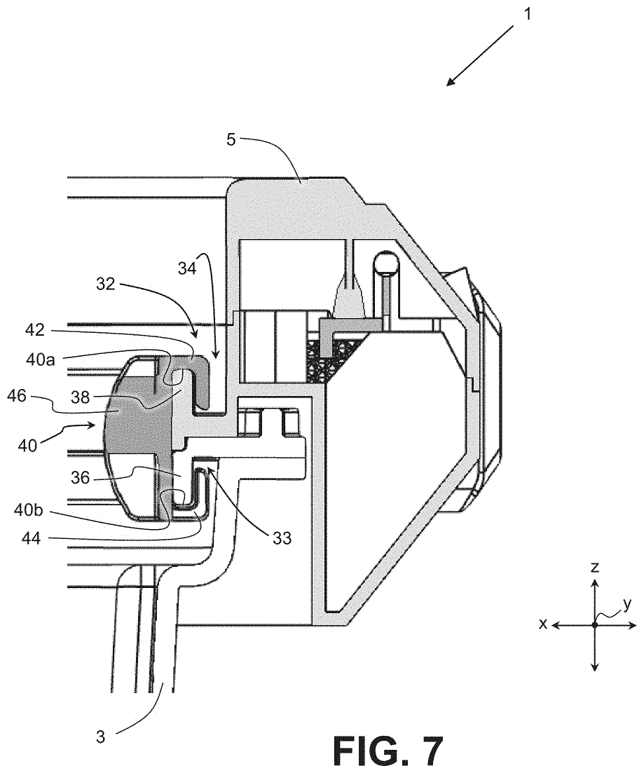

As best shown in FIGS. 4, 6, and 7, a linking mechanism 32 links the smart lid 5 to the case body 3. FIG. 7 illustrates a cross-sectional view of a portion of the case 1 of FIG. 3 specifically showing the exemplary linking mechanism 32. The linking mechanism 32 may include the first linking mechanism portion 33 which is part of or is attached to the main body 3 and the second linking mechanism portion 34 which is part of or is attached to the lid 5. The first linking mechanism portion 33 interacts with the second linking mechanism portion 34 to link and unlink the lid 5 to the case body 3. The linking mechanism 32 is not accessible when the lid 5 is linked to the case body 3 and the door 13 is closed.

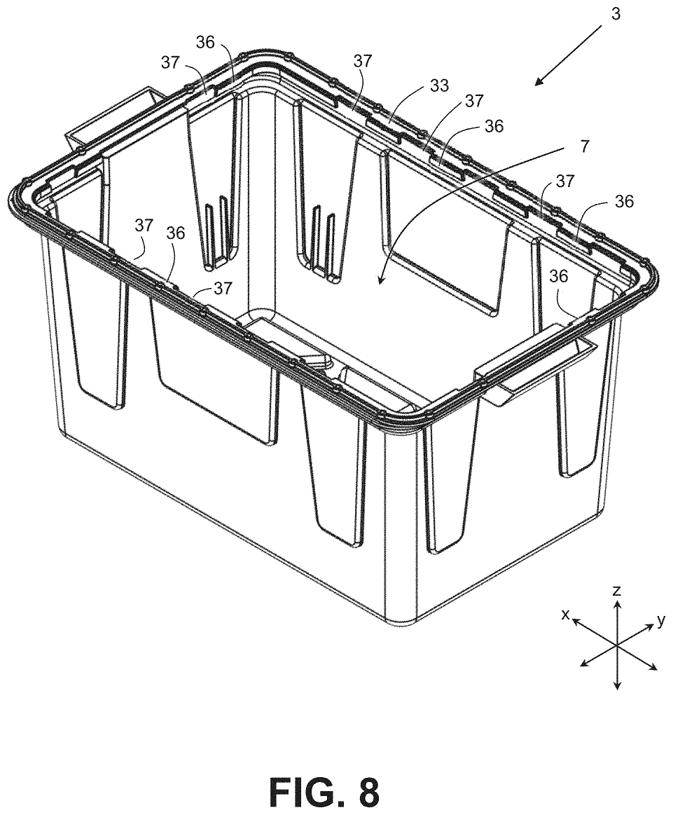

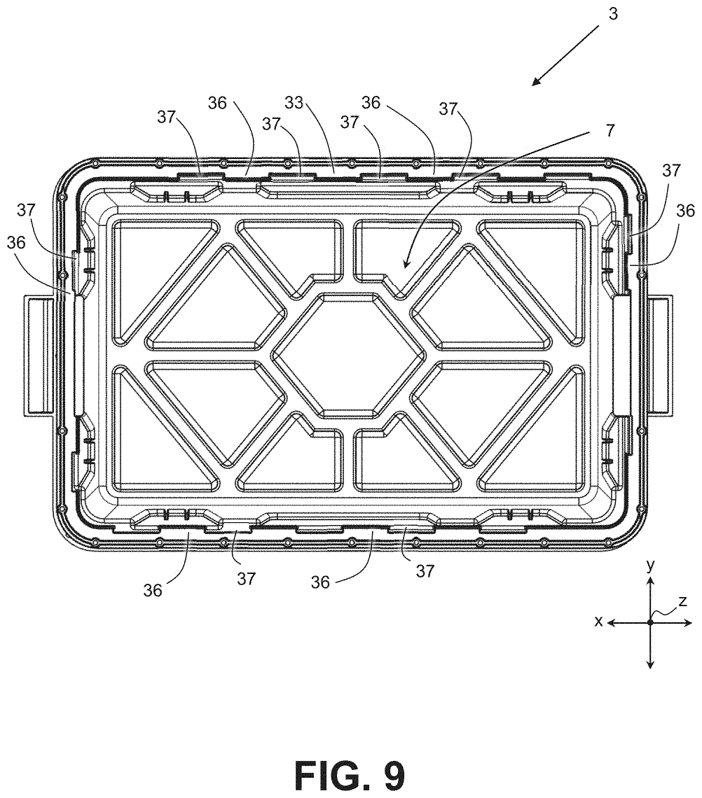

As best shown in FIGS. 8 and 9, the first linking mechanism portion 33 includes or takes the form of a rectangular (to match the perimeter of the case body 3′s opening) bracket that has flanges 36 extending into the cavity 7, away from the lid 5, and gaps 37 between the flanges 36. The bracket 33, in this example, is mounted to the rest of the case body 3. In the illustrated embodiment of FIG. 7, the second linking mechanism portion 34 includes a bracket having a flange 38 extending away from the case body 3. The bracket 34, in this example, is formed on the lid 5. The flange 38 may be a continuous flange 38 at least along each side (front, rear, right, left) of the lid 5, in contrast with the flanges 36 of the case body 3 which have the gaps 37 therebetween.

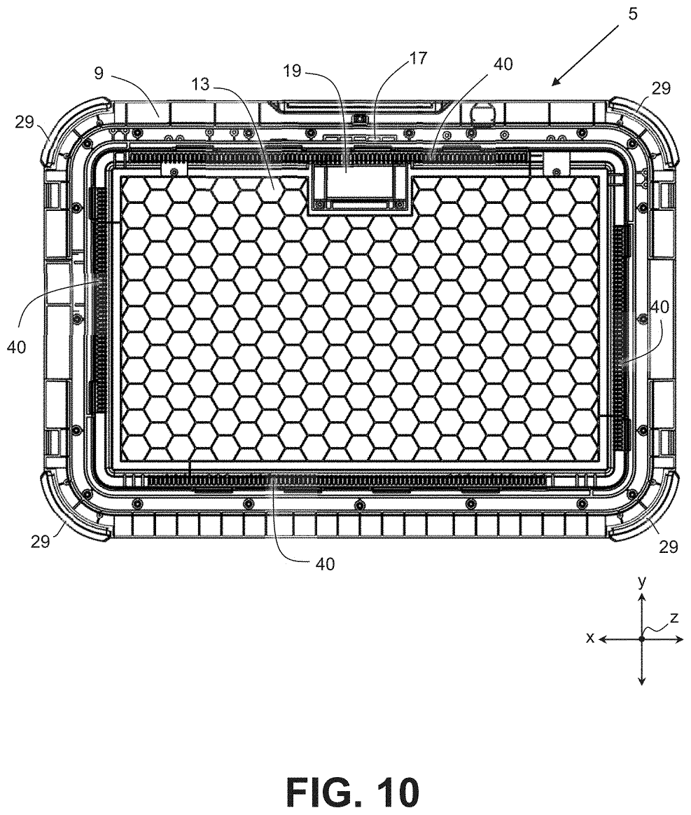

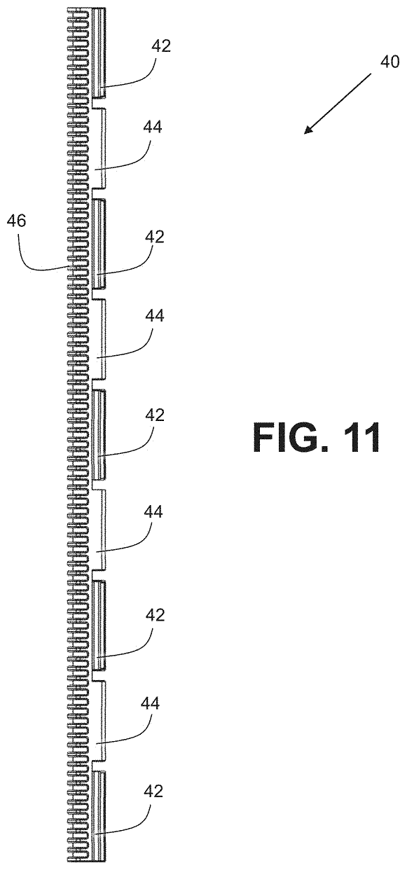

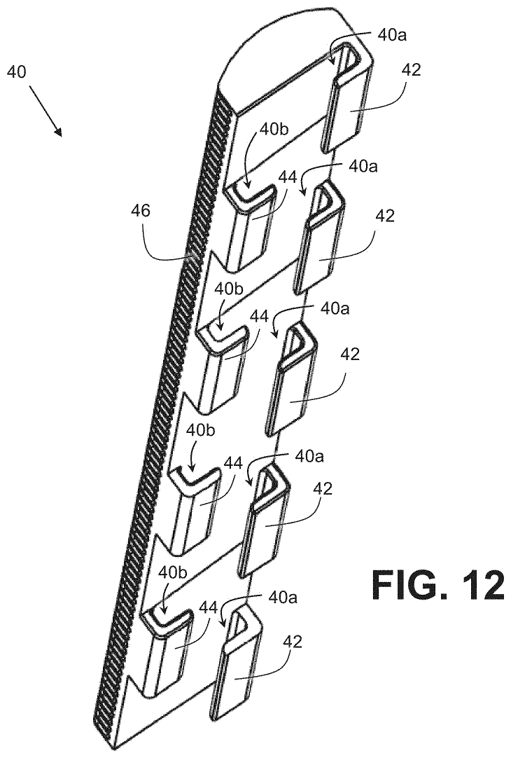

In the illustrated embodiment, the linking mechanism 32 also includes a sliding clasp 40 that clasp the brackets 33 and 34 together to link the case body 3 and the lid 5. FIG. 10 illustrates a bottom view of the exemplary lid 5. As best seen from FIG. 10, the case 1 may include four of the sliding clasps 40. FIGS. 11 and 12 illustrate front and perspective views of a clasp 40. The clasps 40 may each have alternating brackets 42, 44 that form the channels 40a, 40b. The clasps 40 may also include a grip portion 46 that a user may interact with to slide the clasp 40.

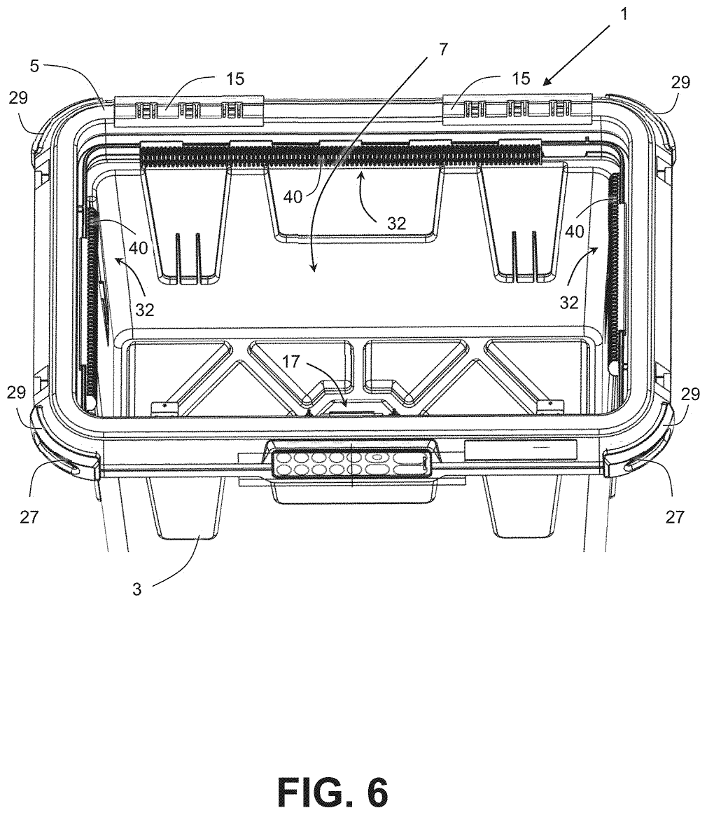

As best seen from FIGS. 6, 7, and 10, the clasps 40 slide longitudinally (along the x direction for clasps 40 on the front and the back of the case 1 and along the y direction for clasps 40 on the right and left sides of the case 1) with the channel 40a riding on the flange 38 of the lid 5. As best seen from FIG. 7, as the clasp 40 slides longitudinally (along the x direction for clasps 40 on the front and the back of the case 1 and along the y direction for clasps 40 on the sides of the case 1), the channels 40b selectively engage and disengage the alternating flanges 36 of the case body 3. At an extreme end of the sliding direction, as shown in FIG. 7, the channels 40b engage the flanges 36 to link the case body 3 and the lid 5. At the opposite extreme end of the sliding direction, the channels 40b disengage the flanges 36 (i.e., the channels 40b align with the gaps 37) to unlink the lid 5 from the case body 3.

Thus, a user may slide all four of the sliding clasps 40 in one direction to link the lid 5 to the case body 3 and slide all four of the sliding clasps 40 in the opposite direction to unlink the lid 5 from the case body 3.

The first linking mechanism portion 33 and the second linking mechanism portion 34 reside fully within the main cavity 7 or the volume formed inside the case 1 including the case body 3 and the lid 5 with the door 13 closed. The door 13, when closed, covers (i.e., impedes access to) the first linking mechanism portion 33, the second linking mechanism portion 34, and the clasps 40 such that linking and unlinking of the lid 5 from the case body 3 is not possible with the door 13 closed. To access the linking mechanism 32, and link or unlink the lid 5 from the case body 3, a user must first gain access to the main cavity 7 by unlocking and opening the door 13 to expose the first linking mechanism portion 33, the second linking mechanism portion 34, and the clasps 40. The door 13, when unlocked, pivots about the hinges 15 to expose the linking mechanism 32, as shown in FIGS. 4 and 6 (FIG. 6 illustrates the case 1 with the door 13 made transparent for ease of illustration of the linking mechanism 32).

Thus, the lid 5 may be unlinked or separated from the case body 3 only when the door 13 is unlocked and open. Since the door 13 may be opened only under the conditions described above (a user entering an unlocking code and/or the case 1 being at a precise geographical location (e.g., delivery location) and/or the case 1 receiving a remote unlocking code), the linking mechanism 32 is accessible only under these conditions. Thus, the case 1 is designed to resist unauthorized unlinking of the lid 5 from the case body 3 absent significant tampering.

In one embodiment, the lid 5 includes one or more sensors that senses whether the linking mechanism 32 has been fully engaged (e.g., switches that detect whether the first linking mechanism portion 33 has engaged the second linking mechanism portion 34 or that the clasps 40 have engaged both the first linking mechanism portion 33 and the second locking mechanism portion 34). The sensors may communicate with the controller 22 so that it may prevent locking of the door 13 in cases where the linking mechanism 32 is not yet fully engaged. This may prevent transport of a case 1 in which the lid 5 is not fully linked to the case body 3.

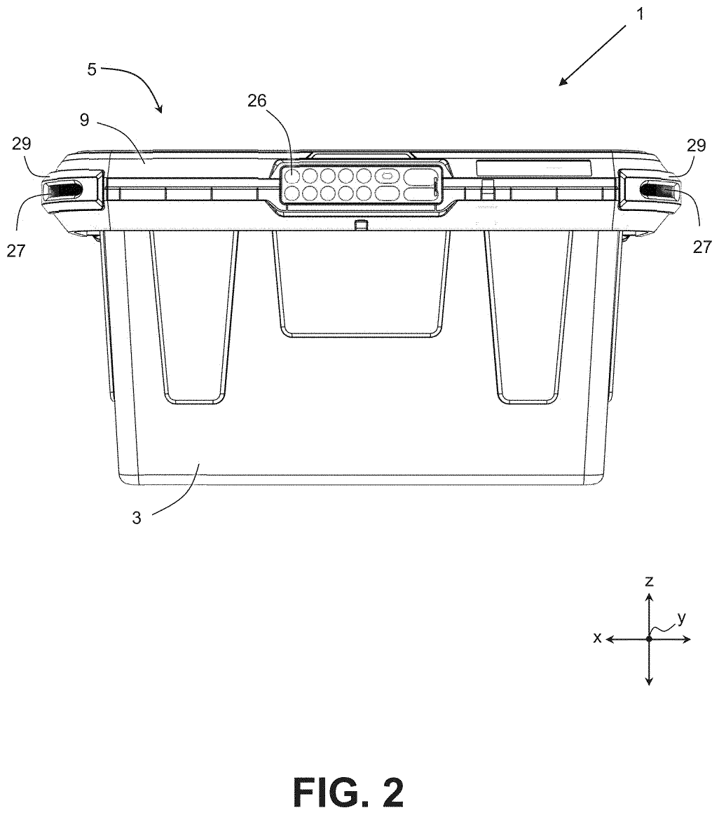

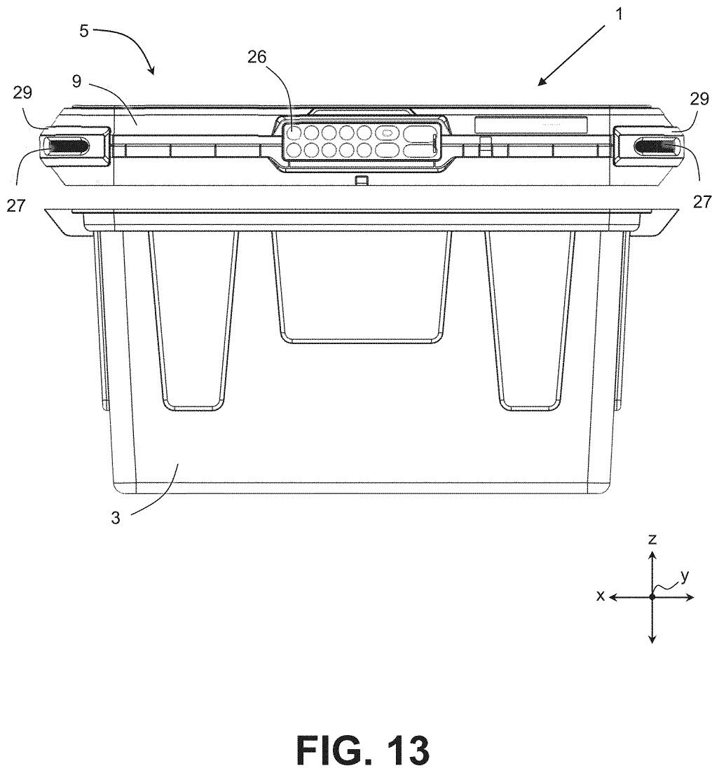

FIG. 2 illustrates the case 1 with the lid 5 linked to the case body 3 while FIG. 13 illustrates the case 1 with the lid 5 unlinked from the case body 3.

The dimensions of the case 1, specifically the cavity 7, may be optimized for the storage and distribution of cannabis (aka marijuana) products, but other high-value goods (e.g., prescription drugs) may also be advantageously stored and transported using the case 1. The case body 3 may, for example, be 20 inches long (x dimension), 15 inches wide (y dimension), and 15 inches tall (z dimension). In another example, the case body 3 may be 24 inches long (x dimension), 20 inches wide (y dimension), and 12 inches tall (z dimension). In other examples, the case body 3 may have other dimensions.

As discussed above, the lid 5 links to the case body 3. A significant feature of the case 1 is that a smart lid 5 that fits a case body 3 of a certain size would also fit another case body 3 of the same length (x dimension) and width (y dimension), regardless of height (z dimension). For example, a smart lid 5 that fits a case body 3 that is 20 inches long (x dimension), 15 inches wide (y dimension), and 5 inches tall (z dimension) would also fit a much taller case body 3 that is 20 inches long (x dimension), 15 inches wide (y dimension), and 15 inches tall (z dimension). Thus, the case 1 provides significant flexibility because the same smart lid 5 (likely the costliest portion of the case 1) may be used with low and high-volume case bodies 3, which may fit small and large amounts, respectively, of the high-value goods.

The construction of the case 1, the case body 3 and the lid 7, may be optimized for the storage and distribution of cannabis (aka marijuana) products or other high-value goods (e.g., prescription drugs). In one embodiment, the case 1 may include a temperature insulated case body 3 or lid 5 to maintain a product stored therein at a desired temperature with or without ice packs stored in the cavity 7.

As disclosed above, multiple cases 1 may be stackable. The lid 5 may also include or have formed thereon ports or brackets 48 configured to secure the case 1. During transport, cases 1 may be secured to each other and/or affixed to the vehicles they are packed in using a security harness fastened through or to one or more of the security ports 48.

In one embodiment, the sensors 23 include an RFID reader. The case 1 may include or accommodate therein liners (e.g., bag-like containers) with or without handles. The high-value goods may be stored in the liners which are then stored in the case 1 for transport and delivery. At the distribution location, the liners may be easily filled and inserted into the case 1. At the delivery location, the liners may be easily removed and delivered to the ultimate recipient for a more seamless delivery process. The liners may include RFID tags readable by the sensors 23 (RFID reader) and ID information transmitted to the controller 22. This way, the controller 22 may identify insertion or removal of specific liners (and thus specific high-value goods, specific batches, etc.) into the case 1. The controller 22 may save this information in the file system 25, the disk 62, or transmit it via the network devices 28 to a remote location. The liners may also have installed printed labels to identify specific high-value goods stored in the liners.

FIG. 14 illustrates a block diagram of exemplary circuitry 20 of the smart lid 5. The circuitry 20 includes the controller 22, a memory 54, and I/O Ports 56 operably connected by a bus 58.

In one example, the circuitry 20 may receive input signals via, for example, I/O Ports 56 or I/O Interfaces 60 to which the sensors 23, GPS 24, keypad 26, and network devices 28 may be connected. The circuitry 20 may also transmit output signals via, for example, I/O Ports 56 or I/O Interfaces 60 to which the first locking mechanism 17, lights 27, local alarms, and network devices 28 may be connected. Thus, the circuitry 20 may be implemented as hardware, firmware, software, or a combination thereof and its components may provide means for performing functions described and/or claimed herein as performed by circuitry 20.

The controller 22 can be a variety of various processors including dual microprocessor and other multi-processor architectures. The memory 54 can include volatile memory or non-volatile memory. The non-volatile memory can include, but is not limited to, ROM, PROM, EPROM, EEPROM, and the like. Volatile memory can include, for example, RAM, synchronous RAM (SRAM), dynamic RAM (DRAM), synchronous DRAM (SDRAM), double data rate SDRAM (DDR SDRAM), and direct RAM bus RAM (DRRAM).

A disk 62 may be operably connected to the circuitry 20 via, for example, an I/O Interfaces (e.g., card, device) 60 and an I/O Ports 56. The disk 62 can include, but is not limited to, devices like a magnetic disk drive, a solid-state disk drive, a floppy disk drive, a tape drive, a Zip drive, a flash memory card, or a memory stick. Furthermore, the disk 62 can include optical drives like a CD-ROM, a CD recordable drive (CD-R drive), a CD rewriteable drive (CD-RW drive), or a digital video ROM drive (DVD ROM). The memory 54 can store processes 64 or data 66, for example. The disk 62 or memory 54 can store an operating system that controls and allocates resources of the circuitry 20.

The bus 58 can be a single internal bus interconnect architecture or other bus or mesh architectures. While a single bus is illustrated, it is to be appreciated that circuitry 20 may communicate with various devices, logics, and peripherals using other busses that are not illustrated (e.g., PCIE, SATA, Infiniband, 1394, USB, Ethernet). The bus 58 can be of a variety of types including, but not limited to, a memory bus or memory controller, a peripheral bus or external bus, a crossbar switch, or a local bus. The local bus can be of varieties including, but not limited to, an industrial standard architecture (ISA) bus, a microchannel architecture (MCA) bus, an extended ISA (EISA) bus, a peripheral component interconnect (PCI) bus, a universal serial (USB) bus, and a small computer systems interface (SCSI) bus.

The circuitry 20 may interact with input/output devices via I/O Interfaces 60 and I/O Ports 56. Input/output devices can include, but are not limited to, the keypad 26, a microphone, a pointing and selection device, a camera to record events taking place in or around the case 1, video cards, displays, disk 62, network devices 28, and the like. The I/O Ports 56 can include but are not limited to, serial ports, parallel ports, and USB ports.

The circuitry 20 can operate in a network environment and thus may be connected to network devices 28 via the I/O Interfaces 60, or the I/O Ports 56. Through the network devices 28, the circuitry 20 may interact with a network. Through the network, the circuitry 20 may be logically connected to remote computers. The networks with which the circuitry 20 may interact include, but are not limited to, a local area network (LAN), a wide area network (WAN), and other networks. The network devices 28 can connect to LAN technologies including, but not limited to, fiber distributed data interface (FDDI), copper distributed data interface (CDDI), Ethernet (IEEE 802.3), token ring (IEEE 802.5), wireless computer communication (IEEE 802.11), Bluetooth (IEEE 802.15.1), Zigbee (IEEE 802.15.4) and the like. Similarly, the network devices 28 can connect to WAN technologies including, but not limited to, point to point links, circuit switching networks like integrated services digital networks (ISDN), packet switching networks, cellular networks (e.g., CDMA, LTE), digital subscriber lines (DSL), etc. While individual network types are described, it is to be appreciated that communications via, over, or through a network may include combinations and mixtures of communications.

While example systems, methods, and so on, have been illustrated by describing examples, and while the examples have been described in considerable detail, it is not the intention to restrict or in any way limit the scope of the appended claims to such detail. It is, of course, not possible to describe every conceivable combination of components or methodologies for purposes of describing the systems, methods, and so on, described herein. Additional advantages and modifications will readily appear to those skilled in the art. Therefore, the invention is not limited to the specific details, and illustrative examples shown or described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

### DEFINITIONS

The following includes definitions of selected terms employed herein. The definitions include various examples or forms of components that fall within the scope of a term and that may be used for implementation. The examples are not intended to be limiting. Both singular and plural forms of terms may be within the definitions.

“Signal,” as used herein, includes but is not limited to one or more electrical or optical signals, analog or digital signals, data, one or more computer or processor instructions, messages, a bit or bit stream, or other means that can be received, transmitted, or detected.

To the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components. An “operable connection,” or a connection by which entities are “operably connected,” is one by which the operably connected entities or the operable connection perform its intended purpose. An operable connection may be a direct connection or an indirect connection in which an intermediate entity or entities cooperate or otherwise are part of the connection or are in between the operably connected entities.

In the context of signals, an “operable connection,” or a connection by which entities are “operably connected,” is one in which signals, physical communications, or logical communications may be sent or received. Typically, an operable connection includes a physical interface, an electrical interface, or a data interface, but it is to be noted that an operable connection may include differing combinations of these or other types of connections sufficient to allow operable control. For example, two entities can be operably connected by being able to communicate signals to each other directly or through one or more intermediate entities like a processor, operating system, a logic, software, or other entity. Logical or physical communication channels can be used to create an operable connection.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (3D. Ed. 1995).

What is claimed is:

1. A case for securely transporting high-value consumer goods, comprising:
a case body having a main cavity within which the high-value consumer goods may be stored for transporting, the case body having installed or formed thereon a first linking mechanism portion;
a lid including a door and a second linking mechanism portion that interacts with the first linking mechanism portion to link and unlink the lid to the case body;
the door, when closed, covers the first linking mechanism portion and the second linking mechanism portion and, when open, exposes at least one of the first linking mechanism portion and the second linking mechanism portion such that linking and unlinking of the lid to the case body is possible only when the door is open.

2. The case of claim 1, the lid including:
a door locking mechanism configured to lock and unlock the door to the lid such that, when the door locking mechanism unlocks the door, the door is openable to expose at least one of the first linking mechanism portion and the second linking mechanism portion such that linking and unlinking of the lid to the case body is possible, and, when the door locking mechanism locks the door, the door covers the first linking mechanism portion and the second linking mechanism portion such that linking and unlinking of the lid to the case body is not possible.

3. The case of claim 2, the lid comprising:
a controller operably connected to the locking mechanism to lock and unlock the locking mechanism;
a GPS tracking device operably connected to the controller and configured to transmit a location signal to the controller, the controller configured to, based on the location signal, permit unlocking of the door only within one or more specific geographical areas.

4. The case of claim 3, the lid comprising:
a keypad operably connected to the controller and configured to transmit a code entered, the controller configured to, based on the location signal and the code entered, unlock the door, or
a receiver operably connected to the controller and configured to receive signals including a remote unlocking signal and to transmit the remote unlocking signal to the controller, the controller configured to, based at least in part on the remote unlocking signal, unlock the door.

5. The case of claim 3, the lid comprising:
at least one temperature or humidity sensor disposed in the lid to measure a temperature or humidity inside the case, the at least one temperature or humidity sensor operably connected to the controller and configured to transmit a temperature or humidity signal to the controller, the controller configured to, based on the temperature or humidity signal, determine and store data representing conditions inside the case.

6. The case of claim 3, the lid comprising:
a transmitter operably coupled to the controller and configured to transmit at least one of location of the case and data representing conditions inside the case including at least one of temperature inside the case and humidity inside the case.

7. The case of claim 3, the lid comprising:
a sensor operably coupled to the controller and configured to detect light inside the case, the sensor operably connected to the controller, and the controller configured to a) cause the transmitter to transmit an alarm or b) cause a local sound when the sensor detects light inside the case while the locking mechanism is locked.

8. A case for securely transporting high-value consumer goods, comprising:
a case body having a main cavity within which the high-value consumer goods may be stored for transporting, the case body having installed or formed thereon a first linking mechanism portion; and
a lid including a door and a second linking mechanism portion that interacts with the first linking mechanism portion to link and unlink the lid to the case body, the first linking mechanism portion and the second linking mechanism portion fully residing within the volume formed by the case including the case body and the lid with the door closed.

9. The case of claim 8, the lid including:
a door locking mechanism configured to lock and unlock the door to the lid such that, when the door locking mechanism unlocks the door, the door is openable to expose at least one of the first linking mechanism portion and the second linking mechanism portion such that linking and unlinking of the lid to the case body is possible, and, when the door locking mechanism locks the door, the door covers the first linking mechanism portion and the second linking mechanism portion such that linking and unlinking of the lid to the case body is not possible.

10. The case of claim 9, the lid comprising:
a controller operably connected to the locking mechanism to lock and unlock the locking mechanism;
a GPS tracking device operably connected to the controller and configured to transmit a location signal to the controller, the controller configured to, based on the location signal, permit unlocking of the door only within one or more specific geographical areas.

11. The case of claim 10, the lid comprising at least one of:
a keypad operably connected to the controller and configured to transmit a code entered, the controller configured to, based on the location signal and the code entered, unlock the door, or
a receiver operably connected to the controller and configured to receive signals including a remote unlocking signal and to transmit the remote unlocking signal to the controller, the controller configured to, based at least in part on the remote unlocking signal, unlock the door.

12. The case of claim 10, the lid comprising:
at least one temperature or humidity sensor to measure a temperature or humidity inside the case, the at least one temperature or humidity sensor operably connected to the controller and configured to transmit a temperature or humidity signal to the controller, the controller configured to, based on the temperature or humidity signal, determine and store data representing conditions inside the case; and
a transmitter operably coupled to the controller and configured to transmit at least one of location of the case and data representing conditions inside the case including at least one of temperature inside the case and humidity inside the case.

13. The case of claim 10, the lid comprising:
a sensor operably coupled to the controller and configured to detect light inside the case, the sensor operably connected to the controller, and the controller configured to a) cause the transmitter to transmit a remote alarm or b) cause a local sound alarm when the sensor detects light inside the case while the locking mechanism is locked.

14. The case of claim 10, the lid comprising:
bumpers disposed at corners or vertices of the lid and configured to absorb impact, at least one of the bumpers having a recess therein in which a light operably connected to the controller resides, the controller configured to cause the light to illuminate when the controller, based on the location signal, determines that the case is at a specific geographical area.

15. A case for securely transporting high-value consumer goods, comprising:
a case body having a main cavity within which the high-value consumer goods may be stored for transporting, the case body having installed or formed thereon a first linking mechanism portion;
a lid including a second linking mechanism portion that interacts with the first linking mechanism portion to link the lid to the case body, a shroud having formed thereon an opening, a door operably connected to the lid to, when closed, cover the opening or at least most of the opening, the second linking mechanism portion disposed behind the door such that linking and unlinking of the lid to the case body is possible only when the door is open.

16. The case of claim 15, the lid including:
a door locking mechanism configured to lock and unlock the door to the lid such that, when the door locking mechanism unlocks the door, the door is openable to expose at least one of the first linking mechanism portion and the second linking mechanism portion such that linking and unlinking of the lid to the case body is possible, and, when the door locking mechanism locks the door, the door covers the first linking mechanism portion and the second linking mechanism portion such that linking and unlinking of the lid to the case body is not possible.

17. The case of claim 16, the lid comprising:
a controller operably connected to the locking mechanism to lock and unlock the locking mechanism.

18. The case of claim 17, the lid comprising at least one of:
a keypad operably connected to the controller and configured to transmit a code entered, the controller configured to, based on the location signal and the code entered, unlock the door, or
a receiver operably connected to the controller and configured to receive signals including a remote unlocking signal and to transmit the remote unlocking signal to the controller, the controller configured to, based at least in part on the remote unlocking signal, unlock the door.

19. The case of claim 17, the lid comprising:
at least one temperature or humidity sensor to measure a temperature or humidity inside the case, the at least one temperature or humidity sensor operably connected to the controller and configured to transmit a temperature or humidity signal to the controller, the controller configured to, based on the temperature or humidity signal, determine and store data representing conditions inside the case; and
the controller configured to transmit or store the data representing conditions inside the case including at least one of temperature inside the case and humidity inside the case.

20. The case of claim 17, the lid comprising:
a sensor operably coupled to the controller and configured to detect light inside the case, the sensor operably connected to the controller, and the controller configured to a) cause the transmitter to transmit a remote alarm or b) cause a local sound alarm when the sensor detects light inside the case while the door is locked.
